(19) United States
(12) Patent Application Publication
(10) Pub. No.: US 2026/0244080 A1
(43) Pub. Date: Aug. 20, 2026

(54) IMAGE CAPTURING DEVICE

(71) Applicant: CHICONY ELECTRONICS CO., LTD., New Taipei City (TW)

(72) Inventor: Meng-Yao HUANG, New Taipei City (TW)

(21) Appl. No.: 19/237,432

(22) Filed: Jun. 13, 2025

(30) Foreign Application Priority Data
Feb. 20, 2025 (TW) 114106331

(51) Int. Cl. G03B 11/04; H04N 23/51

(52) U.S. Cl. CPC G03B 11/043; H04N 23/51

(57) ABSTRACT

An image capturing device comprises a housing, a main shielding member and a sub-shielding member. The housing comprises a first light-transmitting portion and a second light-transmitting portion. The main shielding member is movably disposed on the housing and is movable between a first position and a second position along a moving direction. The main shielding member comprises a first shielding portion, a first pushing portion and a second pushing portion opposite to each other. The sub-shielding member comprises an abutting portion and a second shielding portion. The abutting portion is movably disposed between the first pushing portion and the second pushing portion. The abutting portion comprises a first abutting surface and a second abutting surface opposite to each other. The second shielding portion is connected to the abutting portion.

### CROSS-REFERENCE TO RELATED APPLICATION

This application claims the priority benefit of Taiwan application serial No. 114106331, filed on Feb. 20, 2025. The entirety of the above-mentioned patent application is hereby incorporated by reference herein and made a part of this specification.

### BACKGROUND

### 1. Technical Field

The present disclosure relates to an image capturing device, and more particularly to a shielding member of an image capturing device.

### 2. Description of the Related Art

With the advancement of communication technology, the demand for image capturing has gradually increased. As a result, various image capturing devices or electronic products equipped with image capturing devices have emerged in the market. For example, electronic devices such as webcams, dashcams, tablet computers, notebook computers, or all-in-one PCs.

As users of electronic products are placing increasing emphasis on cybersecurity and privacy, image capturing devices equipped with shielding members (i.e., shutters) have become available on the market. The shielding member is disposed adjacent to the lens and is movable to a position covering the lens, thereby blocking the lens's field of view to prevent unauthorized surveillance caused by hacker intrusion.

For image capturing devices with night vision functionality, it is necessary to either increase the width of the shielding member or add an additional shielding member to simultaneously shield or expose both the lens of main camera and the lens of the infrared camera (i.e., IR camera). However, even with a design employing two shielding members, both shielding members must be moved simultaneously. Accordingly, a longer moving distance (or moving space) must be reserved for accommodating either the wider shielding member or the two shielding members, which in turn increases the overall size of the image capturing device. Accordingly, there is a need for improvement.

### SUMMARY

In view of the issue above, it is a primary object of the present disclosure to provide a an image capturing device, which, through a novel design of a main shielding member and a sub-shielding member, addresses the problem of increased device size in prior art image capturing devices caused by the need to simultaneously shield the lens of the main camera and the lens of the infrared camera.

To achieve the above objective, the present disclosure provides an image capturing device, which comprises a housing, a main shielding member and a sub-shielding member. The housing comprises a first light-transmitting portion and a second light-transmitting portion. The main shielding member is movably disposed on the housing and is movable between a first position and a second position along a moving direction. The main shielding member comprises a first shielding portion, a first pushing portion and a second pushing portion opposite to each other. The sub-shielding member comprises an abutting portion and a second shielding portion. The abutting portion is movably disposed between the first pushing portion and the second pushing portion. The abutting portion comprises a first abutting surface and a second abutting surface opposite to each other. The second shielding portion is connected to the abutting portion. When the main shielding member is at the first position, the first pushing portion abuts against the first abutting surface, the main shielding member shields the first light-transmitting portion, and the sub-shielding member shields the second light-transmitting portion. When the main shielding member moves a predetermined distance from the first position, the second pushing portion abuts against the second abutting surface and drives the sub-shielding member to move together. When the main shielding member moves to the second position, both the first light-transmitting portion and the second light-transmitting portion are exposed.

According to an embodiment of the present disclosure, the predetermined distance is a difference between a distance between the first pushing portion and the second pushing portion and a width of the abutting portion.

According to an embodiment of the present disclosure, the image capturing device further comprises a main lens and an infrared imaging lens. The first light-transmitting portion covers a field of view of the main lens. The second light-transmitting portion covers a field of view of the infrared imaging lens.

According to an embodiment of the present disclosure, the predetermined distance is greater than a difference between an inner diameter of the first light-transmitting portion and an inner diameter of the second light-transmitting portion.

According to an embodiment of the present disclosure, a shortest distance between the first light-transmitting portion and the second light-transmitting portion is greater than or equal to an inner diameter of the second light-transmitting portion.

According to an embodiment of the present disclosure, a distance between the first pushing portion and the second pushing portion is greater than or equal to an inner diameter of the first light-transmitting portion.

According to an embodiment of the present disclosure, the main shielding member further comprises an operation portion and a body portion. The operation portion is disposed on the body portion. The first shielding portion extends from one side of the body portion, and an angle is formed between the first shielding portion and the body portion.

According to an embodiment of the present disclosure, the main shielding member further comprises a first fixing portion, which is connected to an end of the first shielding portion opposite to the body portion. The body portion and the first fixing portion abut against an inner sidewall of the housing.

According to an embodiment of the present disclosure, the main shielding member further comprises a sliding groove located on a sidewall of the body portion. The sliding groove is disposed adjacent to the first shielding portion and arranged parallel to the moving direction.

According to an embodiment of the present disclosure, the first pushing portion and the second pushing portion are located at opposite sides of the sliding groove, and the abutting portion is movably disposed within the sliding groove.

According to an embodiment of the present disclosure, the housing further comprises a sliding rail located on an inner sidewall of the housing and arranged parallel to the sliding groove. The abutting portion further comprises a fixing groove sleeved on the sliding rail.

According to an embodiment of the present disclosure, the sub-shielding member further comprises a second fixing portion connected to an end of the second shielding portion opposite to the abutting portion. The second fixing portion abuts against an inner sidewall of the housing.

According to an embodiment of the present disclosure, the sub-shielding member further comprises an inclined portion. Two opposite ends of the inclined portion are respectively connected to the abutting portion and the second shielding portion, and the inclined portion is inclined in a direction away from the first light-transmitting portion and toward the second light-transmitting portion.

According to an embodiment of the present disclosure, the main shielding member further comprises a positioning recess portion, and a part of the abutting portion is received in the positioning recess portion.

According to an embodiment of the present disclosure, the moving direction of the main shielding member is parallel to a longitudinal direction of the housing.

In continuation of the above, the image capturing device according to the present disclosure comprises a housing, a main shielding member, and a sub-shielding member. The main shielding member is movably disposed on the housing. The main shielding member comprises a first shielding portion, a first pushing portion and a second pushing portion opposite to each other. The sub-shielding member comprises an abutting portion and a second shielding portion. The abutting portion is movably disposed between the first pushing portion and the second pushing portion. In other words, the width of the abutting portion is smaller than the distance between the first pushing portion and the second pushing portion, such that the abutting portion is movable therebetween. When the main shielding member is located at a first position, the main shielding member and the sub-shielding member respectively shield a first light-transmitting portion and a second light-transmitting portion of the housing. After the main shielding member moves a predetermined distance from the first position, it drives the sub-shielding member to move together. When the main shielding member moves to a second position, both the first light-transmitting portion and the second light-transmitting portion are exposed. Through the design in which the abutting portion is movable between the first pushing portion and the second pushing portion (i.e., over the predetermined distance), the moving paths of the main shielding member and the sub-shielding member have an overlapping region. As a result, the main shielding member, the sub-shielding member, the main lens, and the infrared imaging lens can be compactly arranged, thereby saving space and reducing the overall size of the image capturing device.

### BRIEF DESCRIPTION OF THE DRAWINGS

FIG. 1 is a schematic view of an image capturing device according to an embodiment of the present disclosure;

FIG. 2 is an exploded schematic view of the main shielding member and the sub-shielding member shown in FIG. 1;

FIG. 3 is a cross-sectional view of the image capturing device taken along line A-A in FIG. 1;

FIG. 4 is a front view of the image capturing device shown in FIG. 1;

FIG. 5 is a schematic view showing the main shielding member and the sub-shielding member after movement, as shown in FIG. 1; and

FIG. 6 is a front view of the image capturing device shown in FIG. 5.

### DETAILED DESCRIPTION OF THE EMBODIMENTS

In order to make the structure, characteristics, and effectiveness of the disclosure further understood and recognized, a detailed description of the disclosure is provided as follows, along with embodiments and accompanying figures.

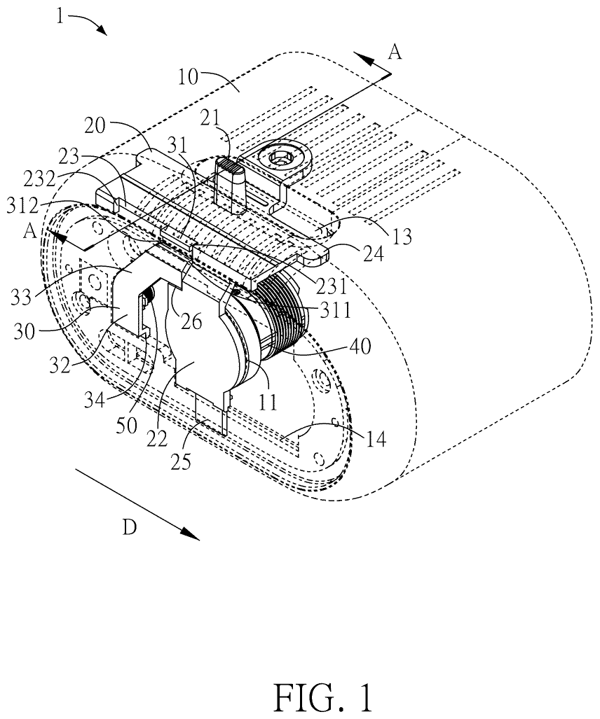

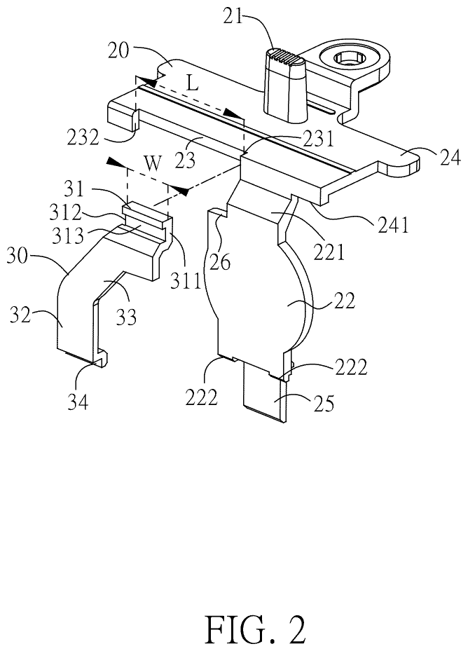

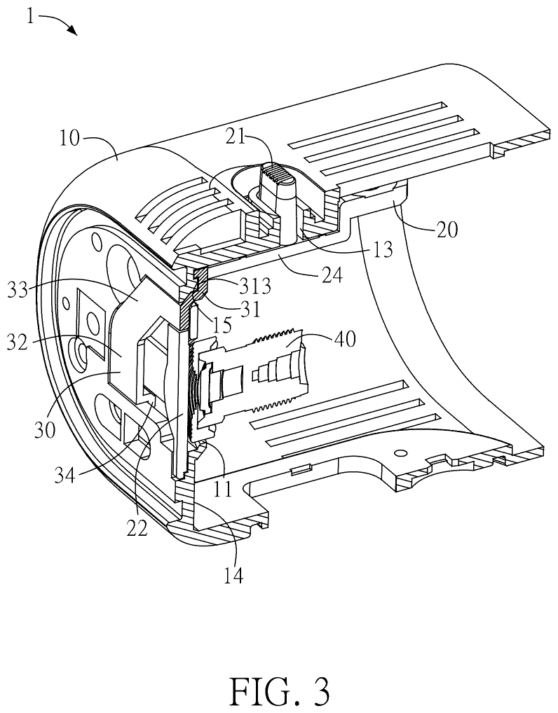

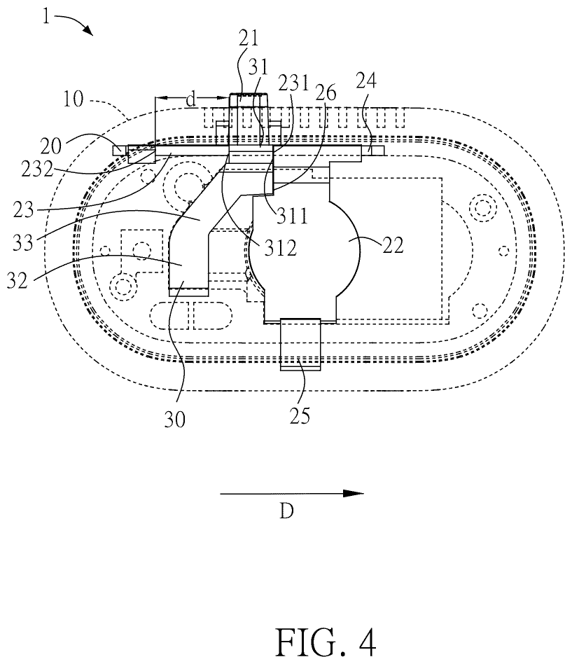

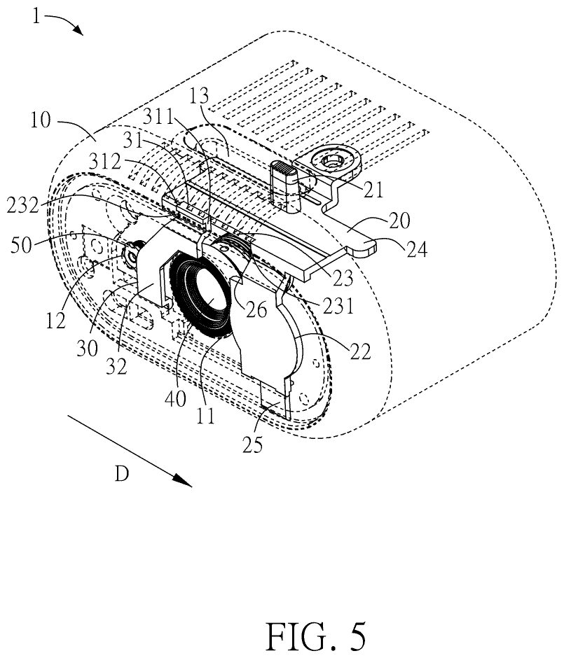

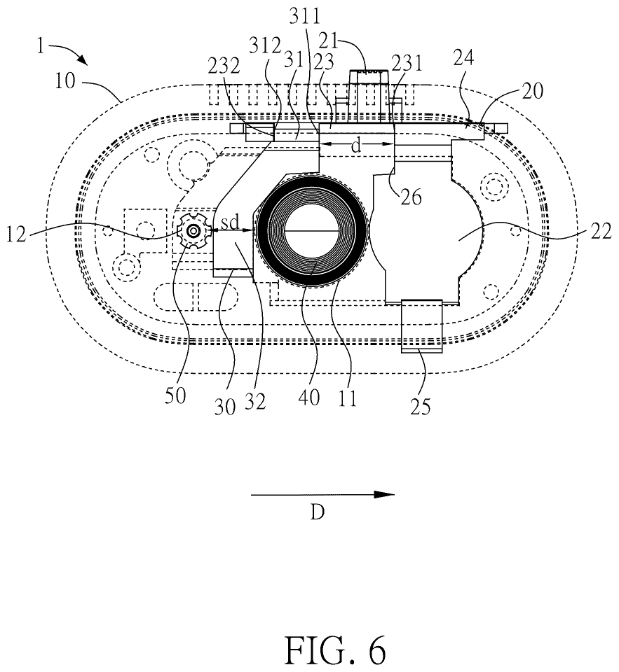

FIG. 1 is a schematic view of an image capturing device according to an embodiment of the present disclosure; FIG. 2 is an exploded schematic view of the main shielding member and the sub-shielding member shown in FIG. 1; FIG. 3 is a cross-sectional view of the image capturing device taken along line A-A in FIG. 1; FIG. 4 is a front view of the image capturing device shown in FIG. 1; FIG. 5 is a schematic view showing the main shielding member and the sub-shielding member after movement, as shown in FIG. 1; and FIG. 6 is a front view of the image capturing device shown in FIG. 5. The following description should be read in conjunction with the above-mentioned figures. First, in the present embodiment, the image capturing device 1 is exemplified as a webcam with night vision functionality. In other embodiments, the image capturing device 1 may also be applied to electronic products such as dash cams, tablet computers, notebook computers, or all-in-one PCs. In the present embodiment, the image capturing device 1 comprises a housing 10, a main shielding member 20, a sub-shielding member 30, a main lens 40, and an infrared imaging lens 50. The housing 10 comprises a first light-transmitting portion 11 and a second light-transmitting portion 12 (refer to the unshielded views in FIG. 5 and FIG. 6), which are located on the front side of the housing 10. It should be noted that, except for FIG. 3, the housing 10, the first light-transmitting portion 11, and the second light-transmitting portion 12 are illustrated in dashed lines. The first light-transmitting portion 11 and the second light-transmitting portion 12 are respectively openings corresponding to the main lens 40 and the infrared imaging lens 50, and are preferably circular openings. It should also be noted that the main lens 40 refers to the lens of a main camera, and the infrared imaging lens 50 refers to the lens of an infrared camera (i.e., IR camera). Generally, the inner diameters of the first light-transmitting portion 11 and the second light-transmitting portion 12 are designed according to the field of view (FOV) of their corresponding lenses. For example, the inner diameter of the first light-transmitting portion 11 is designed based on the field of view of the main lens 40 from the front side of the housing 10, while the inner diameter of the second light-transmitting portion 12 is designed based on the field of view of the infrared imaging lens 50 from the front side of the housing 10. Accordingly, the inner diameter of the first light-transmitting portion 11 covers the field of view of the main lens 40, and the inner diameter of the second light-transmitting portion 12 covers the field of view of the infrared imaging lens 50.

In the present embodiment, the main shielding member 20 is movably disposed on the housing 10 and is movable between a first position and a second position. The main shielding member 20 is shown at the first position in FIG. 1 and FIG. 4, and at the second position in FIG. 5 and FIG. 6. Specifically, the main shielding member 20 comprises an operation portion 21, a first shielding portion 22, and a sliding groove 23. The first shielding portion 22 is connected to the operation portion 21. The operation portion 21 receives an operation to drive the main shielding member 20 to reciprocate along a moving direction D between the first position and the second position. The sliding groove 23 is arranged in parallel with the moving direction D. In the present embodiment, the moving direction D of the main shielding member 20 is parallel to the arrangement direction of the first light-transmitting portion 11 and the second light-transmitting portion 12. In other words, the main shielding member 20 and the sub-shielding member 30 can move back and forth along the moving direction D of the housing 10 to shield or expose the first light-transmitting portion 11 and the second light-transmitting portion 12.

Preferably, the main shielding member 20 in this embodiment further includes a body portion 24, and the operation portion 21 is disposed on the body portion 24. The body portion 24 is a protrusion, and the operation portion 21 is disposed on the upper surface of the body portion 24. Correspondingly, the housing 10 preferably comprises a positioning groove 13 located on the upper side of the housing 10, as shown in FIG. 1, FIG. 3, and FIG. 5. The positioning groove 13 is also arranged in parallel with the moving direction D. The operation portion 21 passes through the positioning groove 13 and protrudes from the upper surface of the housing 10, allowing the user to slide the operation portion 21 from outside the housing 10.

The first shielding portion 22 is configured to shield or expose the first light-transmitting portion 11, and thus corresponds to the front side of the housing 10. Preferably, the first shielding portion 22 may be a circular or arc-shaped plate resembling the appearance of the main lens 40, but the present disclosure is not limited thereto. In this embodiment, the first shielding portion 22 extends from one side of the body portion 24, and an angle is formed between the first shielding portion 22 and the body portion 24. Specifically, as shown in FIG. 2, the first shielding portion 22 further comprises an inclined portion 221 on the side facing the body portion 24. The inclined portion 221 connects the side of the body portion 24 facing the first light-transmitting portion 11, such that the first shielding portion 22 extends outwardly and downwardly from the body portion 24. To save space occupied by the main shielding member 20 inside the housing 10, the first shielding portion 22 is preferably arranged approximately perpendicular to the body portion 24. Because the first shielding portion 22 is connected to the operation portion 21 via the body portion 24, the user can simultaneously drive the first shielding portion 22 to move by sliding the operation portion 21 along the positioning groove 13.

Preferably, the main shielding member 20 in this embodiment further comprises a first fixing portion 25 connected to the end of the first shielding portion 22 opposite to the body portion 24. The body portion 24 and the first fixing portion 25 together abut against an inner sidewall 14 of the housing 10, as shown in FIG. 1, thereby fixing the first shielding portion 22 to the front side of the housing 10. Specifically, the two opposite ends of the first shielding portion 22 are the body portion 24 and the first fixing portion 25. The body portion 24 and the first fixing portion 25 are recessed inward relative to the first shielding portion 22, allowing them to abut against the inner sidewall 14 on the front side of the housing 10. Refer to FIG. 1, FIG. 2, and FIG. 3. For example, the corner 241 of the body portion 24 near the first shielding portion 22 and the inclined portion 221 of the first shielding portion 22 abut against the inner sidewall 14 above the first light-transmitting portion 11, while the two lower corners 222 of the first shielding portion 22 and the first fixing portion 25 are supported against the inner sidewall 14 below the first light-transmitting portion 11. At this point, the first shielding portion 22 is located outside the housing 10 to shield the first light-transmitting portion 11.

Refer to FIG. 1, FIG. 2, and FIG. 4. In this embodiment, the sliding groove 23 is located on the sidewall of the body portion 24 and is disposed adjacent to the first shielding portion 22. Specifically, the sidewall of the body portion 24 facing the front side (i.e., the side facing the first light-transmitting portion 11 and the second light-transmitting portion 12) is recessed inward to form the sliding groove 23, so that the sliding groove 23 is positioned next to the first shielding portion 22. In this embodiment, the sliding groove 23 comprises a first pushing portion 231 and a second pushing portion 232 opposite to each other. Taking FIG. 2 as an example, the first pushing portion 231 and the second pushing portion 232 are the inner sidewalls on the right and left sides of the sliding groove 23, respectively. The first pushing portion 231 and the second pushing portion 232 of the sliding groove 23 are configured to drive the sub-shielding member 30 to move.

The sub-shielding member 30 of this embodiment comprises an abutting portion 31 and a second shielding portion 32. The abutting portion 31 is movably disposed within the sliding groove 23. In other words, the width of the abutting portion 31 is smaller than the length of the sliding groove 23, allowing the abutting portion 31 to move within the sliding groove 23. The second shielding portion 32 is directly or indirectly connected to the abutting portion 31 and is used to shield or expose the second light-transmitting portion 12. Preferably, the sub-shielding member 30 further comprises an inclined portion 33. In this embodiment, the second shielding portion 32 is indirectly connected to the abutting portion 31 via the inclined portion 33. Specifically, the two opposite ends of the inclined portion 33 are connected to the abutting portion 31 and the second shielding portion 32, respectively, and the inclined portion 33 is inclined in a direction away from the first light-transmitting portion 11 and toward the second light-transmitting portion 12. As shown in FIG. 4, the inclined portion 33 is inclined leftward and downward from the abutting portion 31, and the second shielding portion 32 is connected to the end of the inclined portion 33 opposite to the abutting portion 31. Furthermore, the structure of the inclined portion 33 allows the sub-shielding member 30 to conform to the shape of the main lens 40 and the first light-transmitting portion 11. In other embodiments, the second shielding portion 32 may also be directly connected to the abutting portion 31, and the present disclosure is not limited thereto. When the main shielding member 20 moves to the second position, it drives the sub-shielding member 30 to move to an open position where the second light-transmitting portion 12 is exposed, as shown in FIG. 5 and FIG. 6. At this time, the sub-shielding member 30 is positioned around the main lens 40 and the first light-transmitting portion 11, thereby achieving the effect of saving installation space.

In the present embodiment, the sub-shielding member 30 is disposed between the housing 10 and the main shielding member 20. As described above, the abutting portion 31 is movably disposed within the sliding groove 23. As shown in FIG. 3, the housing 10 of this embodiment further comprises a sliding rail 15 located on the inner sidewall 14 at the front side of the housing 10. The sliding rail 15 is parallel to the sliding groove 23, that is, parallel to the moving direction D. Correspondingly, the abutting portion 31 of the sub-shielding member 30 further comprises a fixing slot 313 located on the side of the abutting portion 31 opposite to the sliding groove 23. In other words, the fixing slot 313 faces the inner sidewall 14 of the housing 10, allowing the fixing slot 313 to be sleeved onto the sliding rail 15, as shown in FIG. 3. At the same time, the fixing slot 313 is sandwiched between the sliding rail 15 and the sliding groove 23. As shown in FIG. 2 and FIG. 3, the fixing slot 313 extends rearward from the upper end of the abutting portion 31, making the fixing slot 313 recessed inward relative to the abutting portion 31 and the second shielding portion 32. When the fixing slot 313 is sleeved onto the sliding rail 15, the second shielding portion 32 can be located on the outside of the housing 10 to shield the second light-transmitting portion 12.

Preferably, the sub-shielding member 30 of this embodiment further comprises a second fixing portion 34. The second fixing portion 34 is connected to the end of the second shielding portion 32 opposite to the abutting portion 31. That is, the second fixing portion 34 is located at the lower end of the second shielding portion 32. Similarly, the second fixing portion 34 is recessed inward relative to the second shielding portion 32, allowing the second fixing portion 34 to abut the inner sidewall 14 of the housing 10.

In this embodiment, after the abutting portion 31 is disposed within the sliding groove 23, the remaining distance (or length) is referred to as a predetermined distance d, as shown in FIG. 4. In other words, the predetermined distance d is the difference between the length L of the sliding groove 23 and the width W of the abutting portion 31. The length of the sliding groove 23 and the width W of the abutting portion 31 are shown in FIG. 2. The length L of the sliding groove 23 refers to the distance between the first pushing portion 231 and the second pushing portion 232. In addition, the abutting portion 31 of this embodiment comprises a first abutting surface 311 and a second abutting surface 312 opposite to each other. The width W of the abutting portion 31 refers to the distance between the first abutting surface 311 and the second abutting surface 312, as shown in FIG. 2.

Furthermore, the predetermined distance d also represents the idle stroke of the sub-shielding member 30 before being pushed by the main shielding member 20. Specifically, when the main shielding member 20 is located at the first position, the first abutting surface 311 of the abutting portion 31 abuts against the first pushing portion 231 of the sliding groove 23, as shown in FIG. 1 and FIG. 4. At this time, the first shielding portion 22 of the main shielding member 20 shields the first light-transmitting portion 11, and the second shielding portion 32 of the sub-shielding member 30 shields the second light-transmitting portion 12. When the main lens 40 and the infrared photography lens 50 need to be used, the user may slide the operating portion 21 of the main shielding member 20 along the moving direction D. Taking FIG. 4 as an example, the user slides the operating portion 21 to the right. The sliding groove 23, together with the main shielding member 20, moves to the right until the second pushing portion 232 contacts the second abutting surface 312 of the sub-shielding member 30. The pushing force exerted by the user on the operating portion 21 is then applied to the second abutting surface 312 via the second pushing portion 232, thereby driving the sub-shielding member 30 to move together to the right. In other words, after the main shielding member 20 moves the predetermined distance d from the first position, the second pushing portion 232 of the sliding groove 23 abuts the second abutting surface 312 of the abutting portion 31, which then drives the sub-shielding member 30 to move together. When the main shielding member 20 moves to the second position, the sub-shielding member 30 is also driven to the open position where the second light-transmitting portion 12 is exposed, thereby simultaneously exposing both the first light-transmitting portion 11 and the second light-transmitting portion 12, as shown in FIG. 5 and FIG. 6. Accordingly, the predetermined distance d is referred to as the idle stroke. Through the design of the idle stroke (i.e., the predetermined distance d), an overlapping movement range between the main shielding member 20 and the sub-shielding member 30 is achieved, thereby enabling a compact arrangement of the main shielding member 20, the sub-shielding member 30, the main lens 40, and the infrared photography lens 50. This effectively saves space and reduces the overall volume of the image capturing device.

Preferably, the predetermined distance d in this embodiment is greater than the difference between the inner diameter of the first light-transmitting portion 11 and the inner diameter of the second light-transmitting portion 12. For example, if the inner diameter of the first light-transmitting portion 11 is 20 mm (i.e., the field of view of the main lens 40 at the front side of the housing 10), and the inner diameter of the second light-transmitting portion 12 is 5 mm (i.e., the field of view of the infrared photography lens 50 at the front side of the housing 10), the difference is 15 mm. The predetermined distance d may be greater than 15 mm. Preferably, the predetermined distance d is slightly greater than the aforementioned difference (e.g., 15 mm), so that when the main shielding member 20 moves to the second position, the sub-shielding member 30 is also moved almost simultaneously to the open position exposing the second light-transmitting portion 12, thereby achieving a space-saving configuration.

Preferably, the distance between the first pushing portion 231 and the second pushing portion 232 is greater than or equal to the inner diameter of the first light-transmitting portion 11. In other words, the length L of the sliding groove 23 (refer to FIG. 2) is greater than or equal to the inner diameter of the first light-transmitting portion 11, for example, greater than or equal to 20 mm. Preferably, the shortest distance sd (i.e., the vertical distance) between the first light-transmitting portion 11 and the second light-transmitting portion 12 is greater than or equal to the inner diameter of the second light-transmitting portion 12, for example, greater than or equal to 5 mm. Through the above dimensional constraints, the effect of saving configuration space and reducing the volume of the image capturing device can be achieved.

As shown in FIG. 5 and FIG. 6, when the main shielding member 20 is located at the second position and the sub-shielding member 30 is at the open position, the second pushing portion 232 of the sliding groove 23 abuts against the second abutting surface 312 of the abutting portion 31. When it is desired to close the main lens 40 and the infrared photography lens 50, the user may slide the operating portion 21 of the main shielding member 20 in the reverse direction along the moving direction D. Taking FIG. 4 as an example, the user slides the operating portion 21 to the left. After the main shielding member 20 moves the predetermined distance d from the second position, the first pushing portion 231 of the sliding groove 23 abuts against the first abutting surface 311 of the abutting portion 31, thereby driving the sub-shielding member 30 to move together. When the main shielding member 20 returns to the first position, the sub-shielding member 30 is also driven to move to the closed position, covering the second light-transmitting portion 12. In this way, both the first light-transmitting portion 11 and the second light-transmitting portion 12 are simultaneously shielded, as shown in FIG. 1 and FIG. 4.

Preferably, the main shielding member 20 of this embodiment further comprises a positioning recess portion 26, which is located near the first pushing portion 231 of the sliding groove 23. When the first pushing portion 231 of the sliding groove 23 abuts against the first abutting surface 311 of the abutting portion 31, part of the abutting portion 31 is accommodated in the positioning recess portion 26. The positioning recess portion 26 can fix the relative positions of the main shielding member 20 and the sub-shielding member 30, thereby assisting the main shielding member 20 in pushing the sub-shielding member 30 to the first position. Preferably, the positioning recess portion 26 is a right-angled recessed structure. Correspondingly, the first abutting surface 311 of the abutting portion 31 also has a right-angled structure. Therefore, when the first pushing portion 231 of the sliding groove 23 moves to the first abutting surface 311 of the abutting portion 31, the positioning recess portion 26 can directly align with the first abutting surface 311, allowing the right-angled structure of the abutting portion 31 to be directly accommodated within the positioning recess portion 26.

As described above, the image capturing device according to the present disclosure comprises a housing, a main shielding member, and a sub-shielding member. The main shielding member is movably disposed on the housing. The main shielding member comprises a first shielding portion, a first pushing portion and a second pushing portion opposite to each other. The sub-shielding member comprises an abutting portion and a second shielding portion. The abutting portion is movably disposed between the first pushing portion and the second pushing portion. In other words, the width of the abutting portion is smaller than the distance between the first pushing portion and the second pushing portion, such that the abutting portion is movable therebetween. When the main shielding member is located at a first position, the main shielding member and the sub-shielding member respectively shield a first light-transmitting portion and a second light-transmitting portion of the housing. After the main shielding member moves a predetermined distance from the first position, it drives the sub-shielding member to move together. When the main shielding member moves to a second position, both the first light-transmitting portion and the second light-transmitting portion are exposed. Through the design in which the abutting portion is movable between the first pushing portion and the second pushing portion (i.e., over the predetermined distance), the moving paths of the main shielding member and the sub-shielding member have an overlapping region. As a result, the main shielding member, the sub-shielding member, the main lens, and the infrared imaging lens can be compactly arranged, thereby saving space and reducing the overall size of the image capturing device.

Although the present disclosure has been explained in relation to its preferred embodiments, it is to be understood that many other possible modifications and variations can be made without departing from the spirit and scope of the disclosure as hereinafter claimed.

What is claimed is:

1. An image capturing device, comprising:
a housing, comprising a first light-transmitting portion and a second light-transmitting portion;
a main shielding member movably disposed on the housing and movable between a first position and a second position along a moving direction, the main shielding member comprising a first shielding portion, a first pushing portion and a second pushing portion opposite to each other; and
a sub-shielding member, comprising:
an abutting portion movably disposed between the first pushing portion and the second pushing portion, the abutting portion comprising a first abutting surface and a second abutting surface opposite to each other; and
a second shielding portion connected to the abutting portion; wherein
when the main shielding member is at the first position, the first pushing portion abuts against the first abutting surface, the main shielding member shields the first light-transmitting portion, and the sub-shielding member shields the second light-transmitting portion;
when the main shielding member moves a predetermined distance from the first position, the second pushing portion abuts against the second abutting surface and drives the sub-shielding member to move together; and
when the main shielding member moves to the second position, both the first light-transmitting portion and the second light-transmitting portion are exposed.

2. The image capturing device according to claim 1, wherein the predetermined distance is a difference between a distance between the first pushing portion and the second pushing portion and a width of the abutting portion.

3. The image capturing device according to claim 1, further comprising:
a main lens, wherein the first light-transmitting portion covers a field of view of the main lens; and
an infrared imaging lens, wherein the second light-transmitting portion covers a field of view of the infrared imaging lens.

4. The image capturing device according to claim 3, wherein the predetermined distance is greater than a difference between an inner diameter of the first light-transmitting portion and an inner diameter of the second light-transmitting portion.

5. The image capturing device according to claim 3, wherein a shortest distance between the first light-transmitting portion and the second light-transmitting portion is greater than or equal to an inner diameter of the second light-transmitting portion.

6. The image capturing device according to claim 3, wherein a distance between the first pushing portion and the second pushing portion is greater than or equal to an inner diameter of the first light-transmitting portion.

7. The image capturing device according to claim 1, wherein the main shielding member further comprises an operation portion and a body portion, the operation portion being disposed on the body portion, the first shielding portion extending from one side of the body portion, and an angle being formed between the first shielding portion and the body portion.

8. The image capturing device according to claim 7, wherein the main shielding member further comprises a first fixing portion connected to an end of the first shielding portion opposite to the body portion, and the body portion and the first fixing portion abut against an inner sidewall of the housing.

9. The image capturing device according to claim 7, wherein the main shielding member further comprises a sliding groove located on a sidewall of the body portion, the sliding groove being disposed adjacent to the first shielding portion and arranged parallel to the moving direction.

10. The image capturing device according to claim 9, wherein the first pushing portion and the second pushing portion are located at opposite sides of the sliding groove, and the abutting portion is movably disposed within the sliding groove.

11. The image capturing device according to claim 9, wherein the housing further comprises a sliding rail located on an inner sidewall of the housing and arranged parallel to the sliding groove, and the abutting portion further comprises a fixing groove sleeved on the sliding rail.

12. The image capturing device according to claim 1, wherein the sub-shielding member further comprises a second fixing portion connected to an end of the second shielding portion opposite to the abutting portion, and the second fixing portion abutting against an inner sidewall of the housing.

13. The image capturing device according to claim 1, wherein the sub-shielding member further comprises an inclined portion, two opposite ends of the inclined portion being respectively connected to the abutting portion and the second shielding portion, and the inclined portion being inclined in a direction away from the first light-transmitting portion and toward the second light-transmitting portion.

14. The image capturing device according to claim 1, wherein the main shielding member further comprises a positioning recess portion, and a part of the abutting portion is received in the positioning recess portion.

15. The image capturing device according to claim 1, wherein the moving direction of the main shielding member is parallel to a longitudinal direction of the housing.
